(19) United States
(12) Patent Application Publication
(10) Pub. No.: US 2025/0007172 A1
(43) Pub. Date: Jan. 2, 2025

(54) RADIATION PATTERN ADAPTABLE BY OBSTACLE BIAS

(71) Applicant: SAGEMCOM BROADBAND SAS, BOIS-COLOMBES (FR)

(72) Inventor: Madani KARTOUT, BOIS-COLOMBES (FR)

(21) Appl. No.: 18/758,913

(22) Filed: Jun. 28, 2024

(30) Foreign Application Priority Data
Jun. 29, 2023 (FR) FR2306917

(51) Int. Cl. H01Q 9/28; H01Q 3/24

(52) U.S. Cl. CPC H01Q 9/285; H01Q 3/247

(57) ABSTRACT

Radiofrequency system includes a main antenna and a radiation pattern adaptation device including a printed circuit, on which two radiating strands and a reflector are printed, and on which a switching circuit is mounted, connected to the two radiating strands and arranged to be controlled, such that when the switching circuit is in a blocked mode, the radiofrequency system has a first radiation pattern; and when the switching circuit is in a passing mode, the two radiating strands form a halfwave dipole antenna, the radiofrequency system thus having a second radiation pattern having an increased or decreased gain in at least one predetermined direction.

The invention relates to the field of equipment comprising radiofrequency systems, such as access points, for example.

### BACKGROUND

The radiation pattern of an antenna depends on several parameters, such as the type of wave propagation that it generates, the shape of the radiating element, its dimensions and the materials which constitute it. According to the abovementioned parameters and to the environment in which the antenna is located, a radiation pattern of a specific shape is created.

In the case of using the MIMO (Multiple Input Multiple Output) technique, the antennas can transmit and receive signals simultaneously. Thus, the combined radiation pattern of all the correlated and uncorrelated antennas is considered, in order to determine the maximum power being able to be emitted or the minimum power being able to be received, as well as the spatial coverage.

It is considered to equip an access point (Wi-Fi access point, for example) of such a MIMO system.

In the access points, the combined radiation patterns are often quasi-isotropic, very i.e. sphere-shaped surrounding the piece of equipment, as the aim is to radiate in all directions, in order to have the best coverage and therefore to keep a good communication quality, independently of the position of the stations.

American regulations (see in particular, FCC (Federal Communications Commission) rules, in particular for AFC (Automated Frequency Coordination)) imposes on access point manufacturers, according to the geographic position of these and of the frequency of the transmission channel, to limit the power transmitted beyond a certain elevation with respect to the horizon to 21 dBm, without bringing into question, the power in the other directions (36 dBm).

It therefore seems interesting to be able to act on the radiation pattern in at least one predefined direction to reduce or increase the gain of the antenna(s) used in said predefined direction(s).

This makes it possible, for example, to modify the radiation pattern of an antenna system to adapt it according to the geographic zone where the piece of equipment integrating said antenna system is used. One same antenna system can thus be used in two regions having different regulations, without redesigning said system. The antenna system could thus be configured, such that it has a certain radiation pattern when it is commercialised in the United States, and another radiation pattern when it is commercialised in Europe.

Modifying the radiation pattern could also be done at the time of its installation at the user's place, or be done in real time, in operation, to improve the effectiveness of the communication, if necessary.

Mechanical, electronic and software techniques are known to modify a radiation pattern.

Mechanical techniques require integrating movable parts in the piece of equipment. These movable parts are not very robust, complex and expensive.

In the case of Wi-Fi radio, LTE, 5GNR antenna systems, etc., the radiation pattern can be deformed in an arbitrary direction according to the beamforming method, by applying directly, via software, phase shifts between the signals sent on each antenna (for example, by varying the Nss, i.e. the Number of Spatial Stream) or by applying time delays (for example, with the CDD (Cyclic Delay Diversity) method), which increases the gain in the directions where the user is located, thus creating a perceptible minor deformation of the latter.

However, these techniques highly depend on the environment in which the communication is established, which makes the shape of the radiation patterns random and therefore uncontrollable.

For directive antenna systems, the beamsteering or radiation pattern offsetting solution, implements a phased antenna array. These are several radiating elements connected to one another with a phased supply array or with variable phase shifters. According to the activated elements and to the phase difference between the elements, the radiation pattern is more or less directive and oriented in a given direction.

The disadvantage is that this technique requires an array of several antennas, which widely takes over from frequencies of the ISM band (Wi-Fi, LTE, etc.) and therefore makes its use impossible on internet access gateways.

### AIM

One or more embodiments aim to adapt, on request, the radiation pattern of at least one antenna:
without acting directly on this antenna, nor on the signals which are sent to it, nor on the radiofrequency components to which it is connected;
without using a movable part;
via an unobtrusive solution.

### SUMMARY

With a view to achieving this aim, a radiofrequency system is proposed, comprising a main antenna and a radiation pattern adaptation device comprising a printed circuit, on which two radiating strands and a reflector are printed, and on which a switching circuit is mounted, connected to the two radiating strands and arranged to be controlled, such that:
when the switching circuit is in a blocked mode, a current circulation between the two radiating strands is blocked and the radiofrequency system has a first radiation pattern;
when the switching circuit is in a passing mode, the current circulation between the two radiating strands is not blocked, such that the two radiating strands form a halfwave dipole antenna, the radiofrequency system thus having a second radiation pattern having, with respect to the first radiation pattern, an increased or decreased gain in at least one predetermined direction.

The radiation pattern adaptation device, positioned in the proximity of the main antenna, therefore be controlled to configure the radiation pattern of the radiofrequency system according to the first radiation pattern or the second radiation pattern.

When the switching circuit is in the closed state (passing mode), the radiating strands and the reflector act as a passive and reflective antenna, which modifies the directivity of the radiofrequency system.

This solution therefore makes it possible to modify the radiation pattern without acting on the main antenna itself, nor on the signals that it receives, nor on the radiofrequency components to which it is connected.

This solution requires a reduced size, as the radiation pattern adaptation device is not bulky. The radiation pattern adaptation device does not require the position of a movable element to be modified to adapt the radiation pattern.

In addition, a radiofrequency system such as described above is proposed, in which the main antenna extends into a first plane, and in which the printed circuit of the radiation pattern adaptation device extends into a second plane perpendicular to the first plane.

In addition, a radiofrequency system such as described above is proposed, in which a first distance between the main antenna and the printed circuit, along a first axis belonging to the first plane and perpendicular to the second plane, is equal to λ/8, and in which a second distance between the main antenna and the printed circuit, along a second axis belonging to the second plane and perpendicular to the first axis, is equal to λ/16.

In addition, a radiofrequency system such as described above is proposed, in which a transmission coefficient between the main antenna and the radiation pattern adaptation device is between −15 dB and −6 dB.

In addition, a radiofrequency system such as described above is proposed, in which the two radiating strands extend successively along a length of the printed circuit, and in which the reflector comprises a main portion which extends over all of said length.

In addition, a radiofrequency system such as described above is proposed, in which the reflector further comprises two secondary portions which each extend from a distinct end of the main portion by being perpendicular to it.

In addition, a radiofrequency system such as described above is proposed, in which each radiating strand is connected to the switching circuit by a coplanar waveguide.

In addition, a radiofrequency system such as described above is proposed, in which:
the radiating strands, the reflector, the coplanar waveguides and the switching circuit are located on a first layer of the printed circuit, the coplanar waveguides and the switching circuit being positioned in a central portion of the first layer, the radiating strands extending on either side of said central portion;
the printed circuit comprises a main ground plane printed on a second layer of the printed circuit, the main ground plane being located in a central portion of the second layer;
ground tracks of the coplanar waveguides, a ground plane of the switching circuit, as well as the reflector, being connected to the main ground plane.

In addition, a radiofrequency system such as described above is proposed, in which the switching circuit comprises a single pole single throw switch.

In addition, a radiofrequency system such as described above is proposed, further comprising a support made of a single part comprising a first part arranged to carry the main antenna and a second part arranged to carry the radiation pattern adaptation device, the second part being arranged to be able to manually insert and uninsert the radiation pattern adaptation device.

In addition, a radiofrequency system such as described above is proposed, comprising a plurality of main antennas each associated with a distinct radiation pattern adaptation device.

In addition, a radiofrequency system such as described above is proposed, the main antennas being arranged to operate according to the MIMO technique.

In addition, a piece of equipment comprising a radiofrequency system such as described above is proposed.

In addition, a piece of equipment such as described above is proposed, the piece of equipment being an access point.

In addition, a control method is proposed, implemented by a processing unit of a piece of equipment such as described above, and comprising the steps of:
acquiring a setpoint aiming to configure a radiation pattern of the radiofrequency system according to the first radiation pattern or the second radiation pattern;
producing a control voltage which depends on said setpoint, and applying said control voltage at the input of the switching circuit.

In addition, a computer program is proposed, comprising instructions which make the processing unit of the piece of equipment such as described above to execute the steps of the control method such as described above.

In addition, a computer-readable storage medium is proposed, on which the computer program such as described above is stored.

The embodiment(s) will be best understood in the light of the following description of particular non-limiting embodiments.

### BRIEF DESCRIPTION OF THE DRAWINGS

Reference will be made to the accompanying drawings, among which:

FIG. 1 represents an access point, in which the radiofrequency system is integrated;

FIG. 2 represents two examples of a first radiation pattern and an associated second radiation pattern;

FIG. 3 is a perspective, front view of the main antenna and of the radiation pattern adaptation device;

FIG. 4 is a view similar to that of FIG. 3, but from behind;

FIG. 5 is a view similar to that of FIG. 3, but from the side;

FIG. 6 represents the upper layer and the lower layer of the printed circuit of the radiation pattern adaptation device;

FIG. 7 represents an electrical diagram of the radiation pattern adaptation device;

FIG. 8 represents a graph comprising curves of the parameters S of the switching circuit with SPST switch, in the passing mode;

FIG. 9 is a figure similar to FIG. 8, in the blocked mode;

FIG. 10 represents the intensity of the magnetic field, of the electric field and of the far field directivity, for different configurations of the main antenna and of the radiation pattern adaptation device;

FIG. 11 represents a graph comprising a curve of the reflection rate of the main antenna, a curve of the reflection rate of the antenna PR, and a curve of the transmission coefficient between the main antenna and the antenna PR;

FIG. 12 represents cross-sections of the radiation pattern along different planes, corresponding to lines 2, 4 and 6 of table 1;

FIG. 13 represents cross-sections of the radiation pattern along different planes, corresponding to the lines of table 2;

FIG. 14 represents a diode switching circuit;

FIG. 15 is a figure similar to FIG. 8, for the diode switching circuit;

FIG. 16 is a figure similar to FIG. 9, for the diode switching circuit;

FIG. 17 is a perspective, side and top view of the support and of the radiation pattern adaptation device;

FIG. 18 is a top view of the access point, in its upper cover;

FIG. 19 represents radiation patterns of the MIMO system at different frequencies and for different configurations of the states of the adaptation devices.

### DETAILED DESCRIPTION

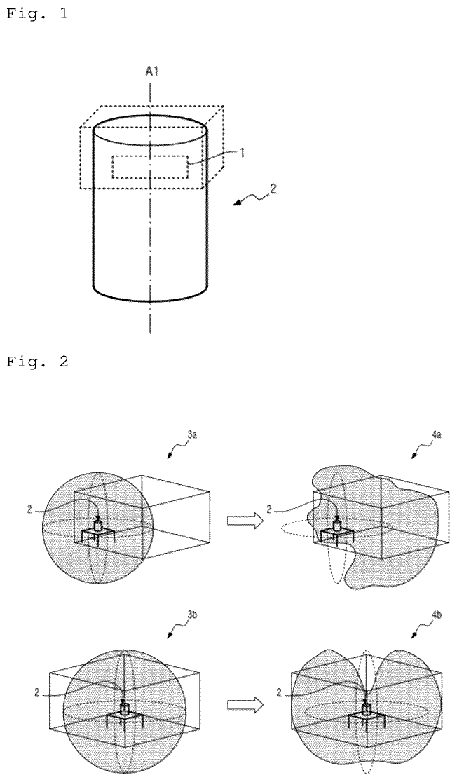

In reference to FIG. 1, the radiofrequency system 1 is, in this case, integrated in the upper part of an access point 2 having a “tower” structure, and which has a general cylindrical shape with an axis A1.

The access point 2 is, for example, a Wi-Fi access point.

The radiofrequency system 1 comprises, in this case, an antenna system arranged to operate according to the MIMO technique.

The radiofrequency system 1 makes it possible to control the shape of the radiation pattern of this MIMO system using a circuit which is external to the antenna system. Controlling the shape of the radiation pattern is done without intervening on the parameters of the radiofrequency components connected to the antenna system (chips, front-end modules (or FEM), etc.), nor on the antenna system itself. In particular, the controlling done does not consist of modifying the number of spatial streams, nor of defining the phase shift between the signals on each antenna, nor of using a precise number of antennas and of choosing which antennas will emit and receive.

The radiofrequency system 1 makes it possible to create an attenuation or an increase of the gain of a single antenna or of an antenna system in a precise direction, on request, with a bias obstacle reflection system. This control does not act on the operation of the antenna system and does not intervene on the physical layers of the radio interface in question, which are controlled by a processor and other electronic chips with specific algorithms.

The radiofrequency system 1 comprises a main antenna or a main antenna system, and a radiation pattern adaptation device. It can, on request, have either a first radiation pattern, close to that of the antenna or of the antenna system, or a second radiation pattern, different from the first radiation pattern.

The modified radiation pattern has a reduced or increased gain in at least one predetermined direction.

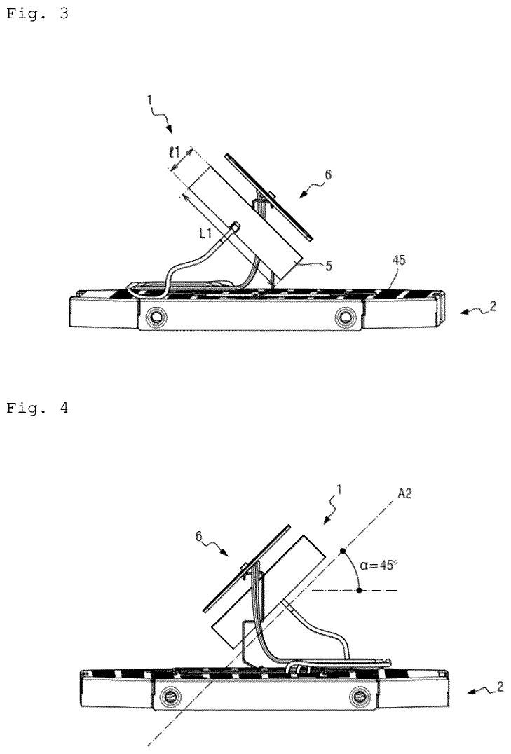

The access point 2 and two typical examples are seen in FIG. 2:
of a first radiation pattern 3a, 3b,
and of the associated second radiation pattern 4a, 4b.

It is seen that the first radiation patterns 3a, 3b are quasi-isotropic, while the second radiation patterns 4a, 4b have gains modified in certain directions.

As will be described, the radiofrequency system 1 makes it possible:
to obtain a radiation pattern having a shape close to that of the “single” antenna(s), when the radiation pattern adaptation device is deactivated;
to deform the radiation pattern(s) without altering the effectiveness of the antenna system, when the radiation pattern adaptation device is activated;
to avoid the movable parts;
to control the radiation patterns over a wide frequency band.

The radiofrequency system 1 is now described in more detail. The radiofrequency system 1 comprises at least one main antenna (in this case, four) and, for each main antenna, a radiation pattern adaptation device adapted to said main antenna.

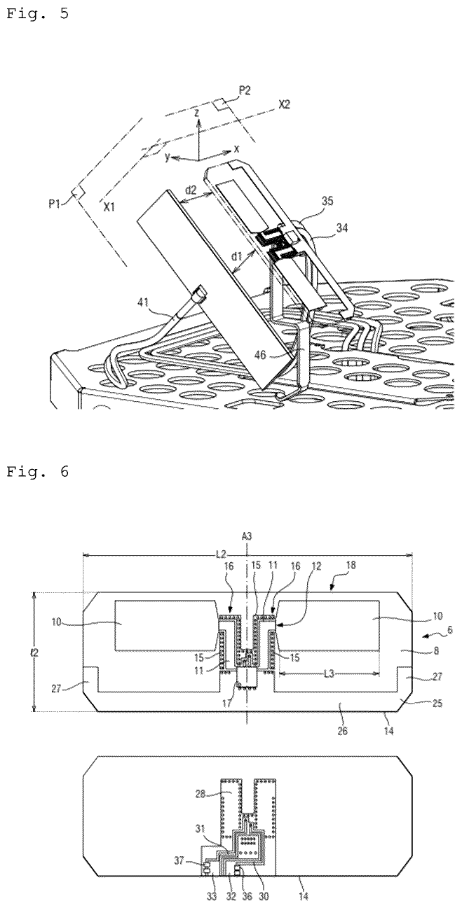

In reference to FIGS. 3 to 7, first an assembly formed by a main antenna 5 and the associated radiation pattern adaptation device 6 are studied.

The main antenna 5 is a TRX antenna (emission and reception antenna), of the patch antenna type. It has a flat and rectangular shape of length L1 and of width 11.

The wavelength corresponding to the central frequency of the bandwidth on which this main antenna 5 is intended to operate is called Δ.

The central frequency is, for example, equal to 5800 MHZ.

When the access point 2, in which the radiofrequency system 1 is integrated, is positioned in its nominal operating position (i.e. placed on a flat and horizontal support), the main antenna 5 extends into a vertical plane by being oriented by an angle α=45° (i.e. that an axis A2, parallel to the length of the main antenna, forms an angle of 45° with a horizontal plane).

The radiation pattern adaptation device 6 comprises a printed circuit 8. Its substrate is, in this case, an FR4 substrate.

The printed circuit 8 has a general rectangular shape, the corners of which are cut.

The printed circuit 8 has a length L2 and a width 12.

Two radiating strands 10 are printed on a first layer (in this case, on the upper layer) of the printed circuit 8. The two radiating strands 10 each are generally rectangular-shaped, and extend successively along the length of the printed circuit 8.

The length L3 of each radiating strand 10 is, in this case, equal to λ/4. λ/4 is the quarter-wave of the central frequency of the operating band of the main antenna.

Each radiating strand 10 is therefore a relatively wide printed track. The two radiating strands 10 each extend on either side of a central axis A3 of the printed circuit 8 extending along its width.

The side (width) of each radiating strand 10 closest to said axis A3 has a general triangular shape (oriented towards the outside of the strand). A track 11 extends from the top 12 of said triangle, then forms a right angle to extend parallel to said axis A3 in the direction of the edge 14 (length) of the printed circuit 8. Ground tracks 15 extend from each side of the track 11. The track 11 and its ground tracks 15 form a coplanar waveguide 16.

The coplanar waveguides 16 are tracks 502.

The two assemblies, each formed by a radiating strand 10 and a coplanar waveguide 16, are disposed symmetrically with respect to the axis A3.

A switching circuit 17 is mounted on the printed circuit 8.

The switching circuit 17 can be controlled, such that:
when the switching circuit 17 is in an open state (blocked mode, OFF), a current circulation between the two radiating strands 10 is blocked and the radiofrequency system 1 has a first radiation pattern;
when the switching circuit 17 is in a closed state (passing mode, ON), the current circulation between the two radiating strands 10 is not blocked, such that the two radiating strands 10 form a halfwave dipole antenna 18, the radiofrequency system 1 thus having a second radiation pattern having, with respect to the first radiation pattern, an increased or decreased gain in at least one predetermined direction.

The switching circuit 17 is, in this case, radiofrequency SPST switch (Single Pole Single Throw switch).

The SPST switch 17 comprises a first port 20 connected to the left radiating strand 10, a second port 21 connected to the right radiating strand 10, a third port 22 (supply) and a fourth port 23 (control). The first port 20 and the second port 21 can therefore be selectively connected (closed state) or disconnected (open state), on request, via the fourth port 23.

When the control voltage Vc is equal to 0V, the SPST switch 17 is in the open state. When the control voltage Vc is equal to 3.3V, the SPST switch 17 is in the closed state.

The SPST switch 17 therefore makes it possible to establish or to cut an electromagnetic connection between the two radiating strands 10. In the closed state, it thus creates the halfwave dipole antenna 18. In the open state, it leaves the radiating strands 10 as very high frequency monopoles.

It has been seen that the coplanar waveguides 16 are tracks 500. The SPST switch 17 therefore has an impedance of 500 at its input and at its output.

This is very advantageous. Indeed, the SPST switch 17 which is used is a standard component which has been designed for an operation at 500 (standard impedance for civil radiofrequency applications). Using a standard component is naturally interesting from the point of view of the cost of the component, but also of its availability.

The SPST switch 17 therefore operates optimally: the signal is passed with a minimum insertion loss and it blocks the signal with a maximum attenuation.

If the coplanar waveguides 16 were not 500 tracks, the SPST switch 17 would not be adapted in impedance and therefore its performance would be deteriorated.

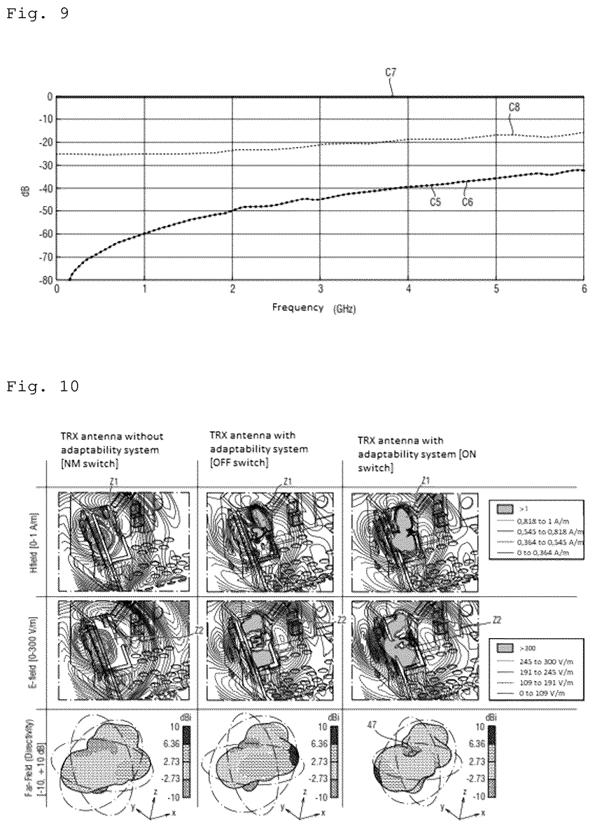

The curves of the parameters S for the SPST switch are seen in FIG. 8: Sij (curve C1), Sji (curve C2), Sii (first port return loss: curve C3), Sjj (second port return loss: curve C4), in passing mode. The same curves, in blocked mode are seen in FIG. 9: curves C5, C6, C7, C8.

The printed circuit 8 comprises, in addition, a reflector 25 printed on the printed circuit 8. The reflector 25 comprises a main portion 26 which extends over the entire length of the printed circuit 8 along the edge 14. This main portion 26 itself comprises a central part which raises towards the centre of the printed circuit 8. The central part of the reflector 25 is located in a central portion of the first layer, in which the guides 16 are also positioned. The radiating strands 10 extend on either side of said central portion.

The reflector 25 further comprises two secondary portions 27 which each extend from a distinct end of the main portion 26 by being perpendicular to it.

The reflector 25 is therefore a track, the length of which is equal to that of the printed circuit 8, and which is folded in a certain way on the ends, with a certain angle to increase the reflectivity level. It must also be noted that the wider this track is, the more reflective it is. This design has been imagined to satisfy a compromise between dimensions, complexity, volume and performance of the solution.

The printed circuit 8 in addition comprises a main ground plane 28 printed on a second layer (in this case, on the lower layer of the printed circuit 8). The main ground plane 28 is positioned in a central portion of the second layer, superposed with the central portion of the first layer.

The ground tracks 15 of the coplanar waveguides 16, the ground plane 29 of the SPST switch 17, as well as the reflector 25, are connected to the main ground plane 28.

The second layer of the printed circuit also comprises a track 30 connected to the third port 22 of the SPST switch 17 (supply) and a track 31 connected to the fourth port 23 of the SPST switch 17. These two tracks 30, 31 each end through a rectangular portion 32, 33, having an edge combined with the edge 14 of the printed circuit 8. A first cable 34, over which a supply voltage Vcc travels, is welded on the portion 32. A second cable 35, over which a control voltage Vc travels, is welded on the portion 33.

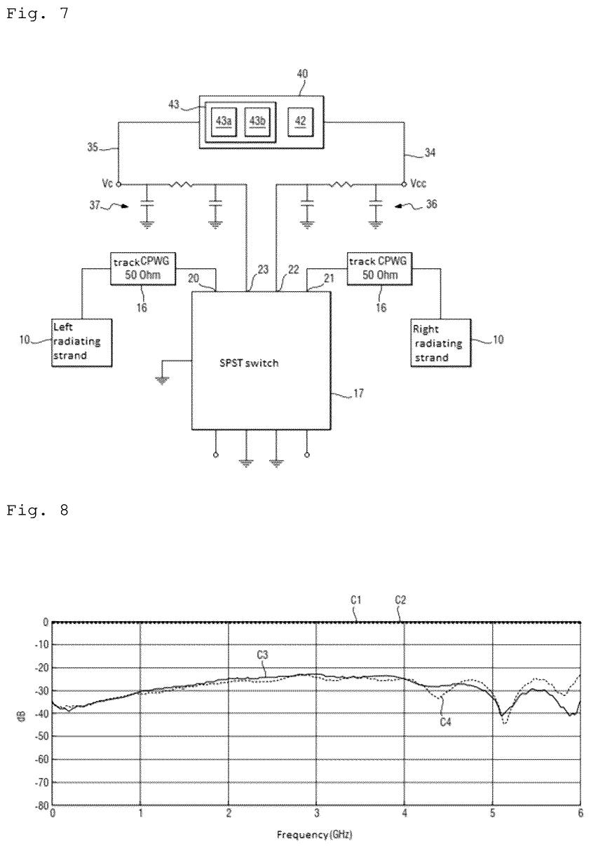

The uncoupling capacities 36 between the main ground plane 28 of the printed circuit 8 and the portion 32 (supply voltage), and between the main ground plane 28 and the portion 33 (control voltage) are seen in FIGS. 6 and 7.

The access point 2 comprises a motherboard 40 which comprises radiofrequency components. The main antenna 5 is connected to the motherboard via a coaxial cable 41 (5002).

The first cable 34 and the second cable 35 are connected to the motherboard 8.

The motherboard 40 comprises a supply unit 42 and a processing unit 43.

The supply unit 42 supplies the supply voltage Vcc to the SPST switch 17 (via the first cable 34).

The processing unit 43 supplies the control voltage Vc to the SPST switch 17 (via the second cable 35). It is therefore the processing unit 43 which controls the evolution of the radiation pattern of the radiofrequency system (passing from the first radiation pattern to the second radiation pattern, and vice versa).

The processing unit 43 comprises at least one processing component 43a, which is, for example, a “general” processor, a processor specialising in the processing of the signal (or DSP, for Digital Signal Processor), a microcontroller, or a programmable logic circuit, such as an FPGA (for Field-Programmable Gate Array) or an (for Application-Specific Integrated Circuit).

The processing circuit 43 in addition comprises one or more memories 43b, which are connected to or integrated into the processing component 43a. At least one of these memories 43b forms a computer-readable storage medium, on which at least one computer program is stored, comprising instructions which make the processing component 43a to execute at least some of the steps of the control method below.

The processing unit 43:
acquiring a setpoint aiming to configure a radiation pattern of the radiofrequency system 1 according to the first radiation pattern or the second radiation pattern;
producing a control voltage Vc which depends on said setpoint, and applying said control voltage at the input of the switching circuit (in this case, on the fourth port 23 of the SPST switch 17).

Now, an optimal position of the main antenna 5 and of the radiation pattern adaptation device 6 is described.

The main antenna 5 extends into a first plane P1, and the printed circuit 8 extends into a second plane P2 perpendicular to the first plane P1.

The radiation pattern adaptation device 6 is therefore positioned perpendicularly above the main antenna 5.

A first distance d1 between the main antenna 5 and the printed circuit 8, along a first axis X1 passing through the first plane P1 and perpendicular to the second plane P2, is equal to λ/8.

A second distance d2 between the main antenna 5 and the printed circuit 8, along a second axis X2 contained in the second plane and perpendicular to the second axis, is equal to λ/16.

The radiation pattern adaptation device 6 is therefore spaced apart from the main antenna 5 of λ/8 on the vertical plane and λ/16 on the horizontal plane of a chosen frequency (by calculating the wavelength in the free space with εr and μr equal to 1).

The main antenna 5 and the radiation pattern adaptation device 6 are connected to a common ground.

This common ground is also a ground of the access point 2. It comprises a metal grid 45 belonging to the frame of the access point 2.

For this, the radiofrequency system 1 comprises a spring ground contact 46, which is fixed to the ground plane 28 of the printed circuit 8 and to the metal grid 45.

Now, the operating principle of the radiofrequency system 1 is described.

When the SPST switch 17 is in the open state (blocked mode), the current circulation between the two radiating strands 10 is blocked and the radiofrequency system 1 has a first radiation pattern, which is substantially that of the main antenna 5 only (it is not fully identical, due to the impact of the printed circuit and the printed tracks on it).

Indeed, even if the system is designed so as to reduce, to the maximum, the occupied surface and the lengths of the conductive elements are different from the wavelengths of the useful frequencies when the system is in blocked mode, it contains, above all, metal conductive elements (strands 10, reflector 25, etc.), which slightly varies the shape of the initial pattern (this depends on the frequencies).

When the SPST switch 17 is in the closed state (passing mode) and when the main antenna 5 emits or receives a radiofrequency signal, i.e. an electromagnetic wave, the dipole antenna 18 formed on the printed circuit 8 of the radiation pattern adaptation device 6 partially receives the radiofrequency signal emitted by the main antenna 5.

It can thus be considered that the printed circuit 8 and its components behave as a passive antenna that will be called PR (Passive Reflective) antenna.

By emitting an electromagnetic wave, the main antenna 5 generates an electric E and magnetic H field in the space around it, with a more or less different mapping according to its radiation pattern.

The electric field induces, in this case, a voltage in the PR antenna between its radiating strands 10, and the magnetic field induces a surface current on the same radiating conductive parts. This voltage and this current circulating over the PR antenna thus create an electromagnetic field, with a different spatial mapping governed by its radiation pattern. The combination of the electromagnetic fields generated by the main antenna and the PR antenna creates a radiation pattern combined with a particular shape, mainly oriented in a predetermined direction. This phenomenon is completely passive. The design of the PR antenna, provided with the reflector 25 printed on the printed circuit 8, increases the directivity of the combined radiation, as the received waves are reflected.

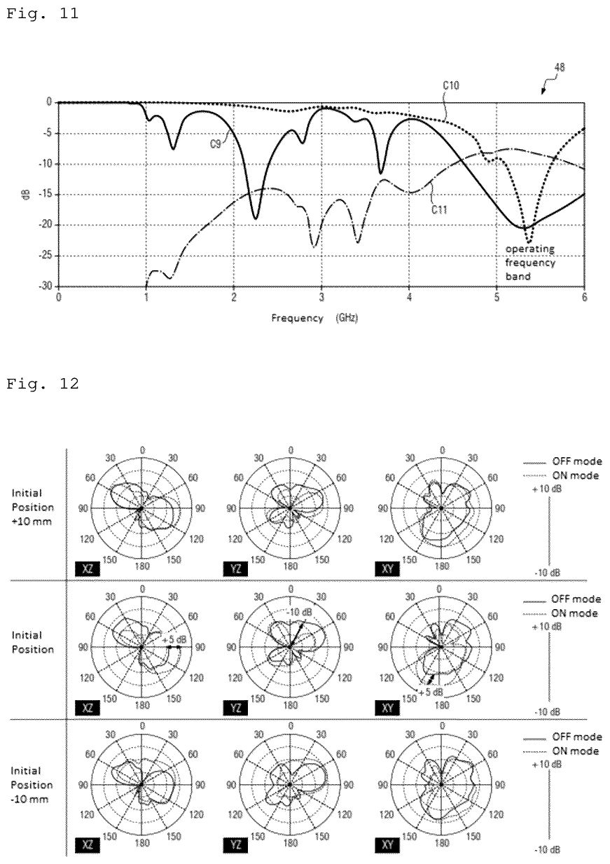

The fields (magnetic field, electric field and far field) for the main antenna 5 are seen in FIG. 10, without the radiation pattern adaptation device 6, with the radiation pattern adaptation device 6 in blocked mode, and with the radiation pattern adaptation device 6 in passing mode.

The magnetic field is maximum in the zones Z1 (greater than 1λ/m). The electric field is maximum in the zones Z2 (greater than 300V/m).

It is seen that with the radiation pattern adaptation device 6 in passing mode, the gain of the radiation pattern increases in the direction of the negative side of the axis X, and decreases in the other direction. The hole 47 is accentuated.

The radiofrequency system 1 thus has a second radiation pattern having, with respect to the first radiation pattern, a gain increased or decreased in at least one predetermined direction.

The effectiveness of the reception of the PR antenna therefore depends on several factors, such as the distance between the antennas, the position of the two antennas, the relative orientation, the radiation features of the main antenna, as well as the dimensions and the electrical properties of the PR antenna.

In this configuration, the PR antenna therefore mainly acts as a receiver and passive reflector which can capture a part of the signal emitted and/or received by the main antenna. It does not amplify and does not improve the quality of the signal.

It is noted that the proximity of the main antenna 5 and of the radiation pattern adaptation device 6 modifies the features of the main antenna 5, and this differently, if the radiation pattern adaptation device 6 forms a reflective halfwave dipole antenna (switch: closed state) or if the metal elements formed by the radiating strands are separated (switch: open state).

The reflection effectiveness, the energy losses and the electromagnetic interactions between the antennas have been considered to obtain the desired performance.

In reference to FIG. 11, the reflection rate (return loss) of the main antenna 5 (curve C9) is low (less than-10 dB) on a bandwidth wider than the useful bandwidth 48 (operating frequency band). This makes it possible to anticipate a frequency offset due to its proximity with the PR antenna and to avoid a drop in its effectiveness which could deteriorate the performance of its radiation and which could deteriorate the performance of the access point 2 due to the reflection level being too high.

The return loss of the PR antenna (curve C10) is also low (less than −10 dB) in the operating frequency band such that it can have the desired impact on the main antenna.

The transmission coefficient (curve C11) between the two antennas, i.e. the coupling, must not be too high to not impact the effectiveness of the main antenna 5 too much, and must not be too low to create a real distinction between the two closed/open states of the SPST switch 17.

If the original signal is already too low, the isolation created by the SPST switch 17 is of little use.

Advantageously, the transmission coefficient between the main antenna 5 and the radiation pattern adaptation device 6 is between −15 dB and −6 dB.

Table 1 (Appendix 1) illustrates an example of behaviour obtained for a radiofrequency system comprising a main antenna and the radiation pattern adaptation device.

The first column (starting from the left) corresponds to the first distance between the main antenna and the radiation pattern adaptation device (along the axis X1). The fourth line (starting from the top) corresponds to the optimal position described above.

The second column corresponds to the state of the SPST switch.

The third column gives directivity values for the three frequencies: 5180 MHz, 5500 MHz and 5800 MHZ.

The fourth column gives the “relative” directivity offsets with respect to the state of the switch and to the position. The fifth column gives the effectiveness, and the sixth column gives the components of the field (in %).

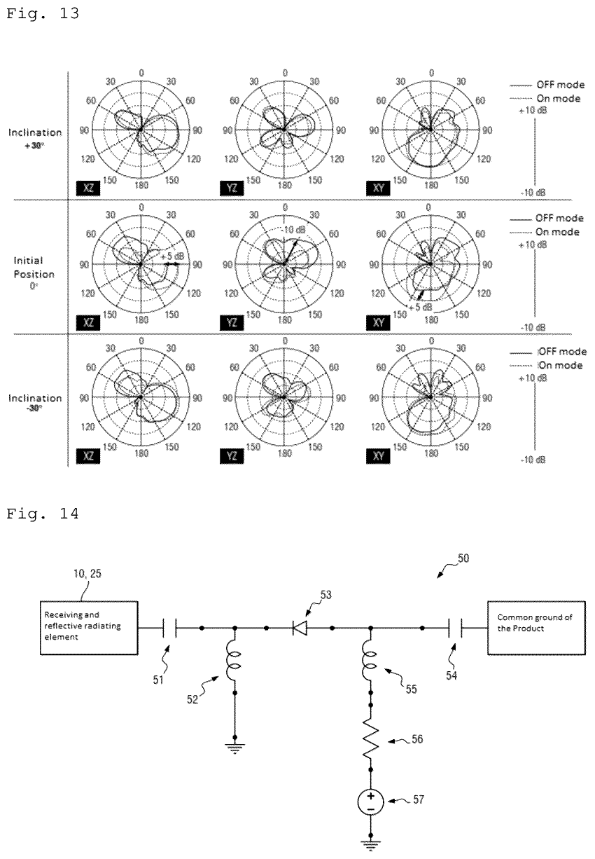

Cross-sections of the radiation pattern (directivity) obtained along different planes are seen in FIG. 12; XZ, YZ and XY (the axes X, Y, Z can be seen in FIG. 5).

Table 2 (Appendix 2) is a table similar to table 1, apart from the fact that this time, in the first column, it is the inclination of the radiation pattern adaptation device 6 which varies.

Cross-sections of the radiation pattern obtained along different planes are seen in FIG. 13; XZ, YZ and XY.

In this case, it is indicated that the switching circuit, i.e. the biasing element of the reception/reflection device, is an SPST switch.

Several other solutions can be considered to pass or block an electronic radiofrequency signal, like diode-, CMOS-MEMS-, circulator- and RF switch-based circuits.

The switching circuit therefore does not necessarily comprise an SPST switch.

However, several 4 the alternatives which can be considered have disadvantages which are difficult to overcome, on the targeted application, due to the charged radiofrequency environment, i. e. due to the wave concentration in a restricted volume which creates electric fields inducing voltages on charged metal elements and magnetic fields which create surface currents randomly on these same metal elements.

The switching circuit can, for example, be a diode switching circuit.

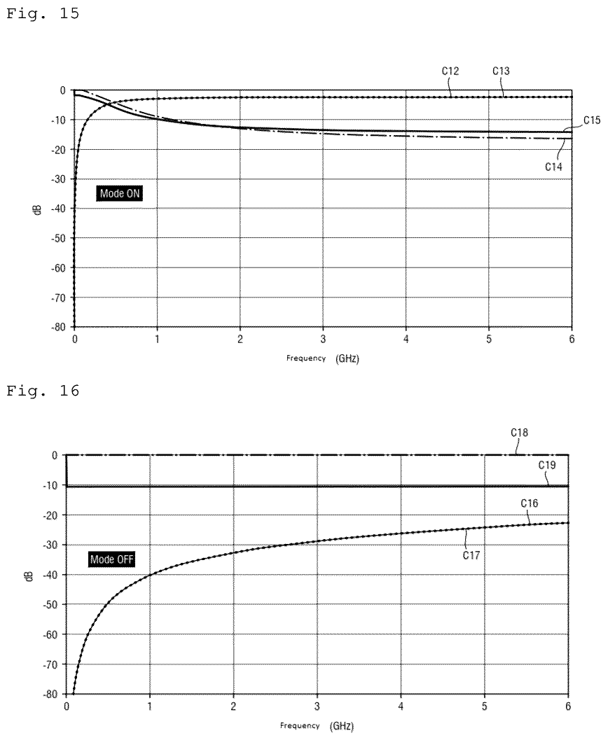

In reference to FIG. 14, the switching circuit 50 comprises a first capacitor 51 having a first terminal connected to the radiating strands 10 and to the reflector 25, a first inductor 52 having a first terminal connected to the second terminal of the first capacitor 51 and a second terminal connected to the electric ground. The cathode of the diode 53 is connected to the second terminal of the first capacitor 51 (and to the first terminal of the first inductor 52). The anode of the diode 53 is connected to a first terminal of the second capacitor 54. The second terminal of the second capacitor 54 is connected to the common ground of the equipment.

The circuit comprises, in addition, a second inductor 55 mounted in series with a resistor 56 and a voltage source 57. The second inductor 55 has a first terminal connected to the anode of the diode 53 and a second terminal connected to the resistor 56.

This circuit has certain disadvantages: relatively high difficulty in finding on the market, very low capacitance radiofrequency diodes covering a wide frequency band and supporting a high input power.

Moreover, it is difficult to control the bias voltage of the diode 53 on a circuit very close to several antennas emitting a power greater than 20 dBm. The risk of this type of mounting is that the diode 53 is permanently biased, and therefore either permanently passing or blocking, which annuls the function sought.

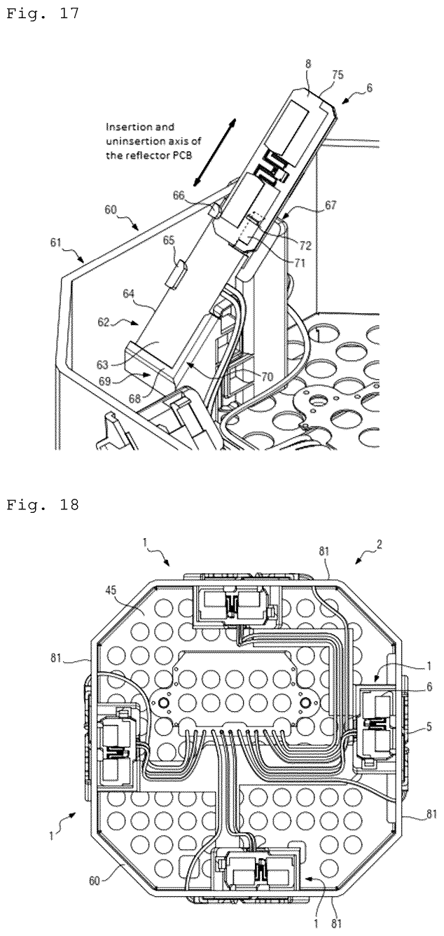

The curves of the parameters S for the diode switching circuit 50 are seen in FIG. 15: Sij (curve C12), Sji (curve C13), Sii (port 1 return loss: curve C14), Sjj (port 2 return loss: curve (15), in passing mode. The same curves, in blocked mode are seen in FIG. 16: curves C16, C17, C18, C19.

In addition to the constraints mentioned above linked to the use of diodes, by comparing FIGS. 8, 9 and 15, 16, it can clearly be seen that the insertion losses are higher on the diode circuit 50 (almost 3 dB in the useful band medium, i.e. that almost 50% of the power of the signal passing through the circuit is lost) and the isolation is around 23 dB, which is not optimal with respect to the SPST switch 17, the insertion losses of which are 0.7 maximum and the isolation is greater than 10 dB (34 dB).

The SPST switch 17, in addition, can easily be found on the market. Its features are known and are more interesting for the present application. This component acts as a switch being able to let a radiofrequency signal pass with a low insertion loss or block it with an isolation around 30 dB on the 5 to 6 GHz band. It can support a maximum input power of 30 dBm, which is broadly sufficient.

Now, in reference to FIG. 17, the mechanical integration of the radiation pattern adaptation device 6 is studied.

The main antenna 5 and the radiation pattern adaptation device 6 are mounted on one same support 60 made of plastic (made of a single part).

The support 60 comprises a first part 61 making it possible to receive the main antenna and to maintain it in the position such as represented in FIGS. 3 to 5.

The support 60 comprises a second part 62 making it possible to receive the radiation pattern adaptation device.

The second part comprises a flat surface 63, generally rectangular-shaped, having substantially the same dimensions as the printed circuit 8. The second part 62 also comprises a set of strips each comprising a first portion which extends perpendicularly to the flat surface 63 and from an edge of it, and a second portion which extends perpendicularly to the first portion and towards the inside of the flat surface 63.

All of the strips comprise, for the edge 64 (length of the flat surface) of the flat surface, a strip 65 located almost at the centre of said edge and of reduced length, a strip 66 located close to the edge 67 (width of the flat surface 63), it also being of reduced length. All of the strips also comprise, a strip 68 which extends over the entire length of the edge 69 (width of the flat surface) and which is extended over a portion of the length of the edge 70 (length of the flat surface) close to half of it.

A flexible finger 71, comprising a flat current portion, is defined in the thickness of the flat surface 63. The finger 71 has an end fixed to the flat surface 63 and a free end from which a hook 72 extends, which projects perpendicularly to the flat surface 63 at the edge 67.

The radiation pattern adaptation device 6 is installed manually in the support 60 as follows. The printed circuit 8 is inserted in the support 60 by being introduced through the edge 67 of the flat surface 63, and by pressing on the hook 72. The printed circuit 8 slides into the space formed between the flat surface 63 and the second portions of the strips. When it is fully inserted, the hook 72 is no longer recessed and projects at the edge 75 of the printed circuit 8 to the outside of it and by pressing against it, which maintains the printed circuit 8 in place. Inserting the printed circuit 8 into the support is therefore done via a slide connection (done thanks to the strips), and maintaining it is done via an elastic interlocking (done by the flexible finger 71).

The radiation pattern adaptation device 6 can therefore be inserted in its support and uninserted manually.

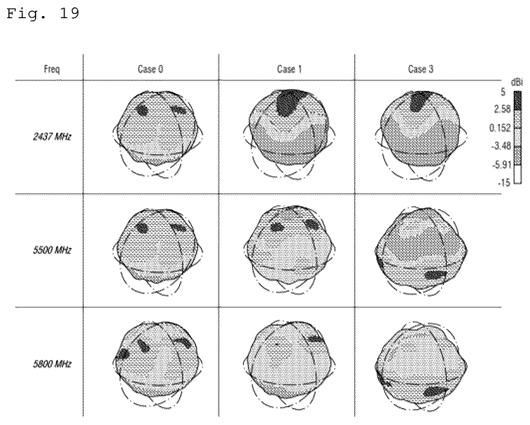

In reference to FIG. 18, the access point 2 comprises a plurality of radiofrequency systems 1 such as described above, the main antennas 5 of said radiofrequency systems being arranged to operate according to the MIMO technique.

In this case, the access point comprises four radiofrequency systems 1.

It is seen that the support 60 mentioned above has an octogonal shape. It carries the four main antennas 5 and the four radiation pattern adaptation devices 6.

The plastic support 60 comprises four large faces 81 and four small faces 82 connecting said large faces 81.

Each radiofrequency system 1, comprising a main antenna 5 and a radiation pattern adaptation device 6, is associated with a distinct large face 81. For each large face 81, the support 60 is arranged such that the main antenna 5 extends to the outside of the support 60 by being oriented at 45° and by being pressed against the external wall of said large face 81, while the radiation pattern adaptation device 6 is located inside the support 60 (the edge 64 of the flat surface 63 goes along the internal wall of said large face 81).

Table 3 of appendix 3 lists different cases, each corresponding to a distinct combination of the embodiments of the radiation pattern adaptation devices.

For example, case 0 corresponds to a case where the radiation pattern adaptation devices are not mounted, case 1 corresponds to a case where the radiation pattern adaptation devices are mounted, but are all in the blocked mode, and case 3 corresponds to a case where the adaptation devices are mounted and are all in the passing mode.

It is noted that, for table 3, the NHPRP (Near Field Horizontal Partial Radiated Power) parameters at +/−45° and at +/−30° have been calculated by using the following equations (equations B.11 and B.12 of section B.3.2 of the CTIA v3.8).:

$$NHPRP 45 = \frac{1}{4 π} {\int }_{θ = π / 4}^{3 π / 4} {\int }_{Φ = 0}^{2 π} ( E i R {P}_{θ} ( θ , Φ ) + E i R {P}_{Φ} ( θ , Φ ) ) sin ( θ ) d θ d Φ$$

$$NHPRP 30 = \frac{1}{4 π} {\int }_{θ = π / 3}^{2 π / 3} {\int }_{Φ = 0}^{2 π} ( E i R {P}_{θ} ( θ , Φ ) + E i R {P}_{Φ} ( θ , Φ ) ) sin ( θ ) d θ d Φ$$

The associated resulting radiation patterns are seen in FIG. 19, for the frequencies 2437 MHZ, 5500 Mhz and 5800 MHZ. For example, the increase of the gain in the direction of the axis Y (in both directions) is distinguished clearly for case 3 at 5800 MHZ.

Naturally, the different embodiments are not limited to the embodiments and examples described, but include any variants entering into the field of the invention.

In other examples, the features of the reflector are such that the reflector is adapted to control the radiation pattern of the main antenna for different central frequencies respectively associated with different operating bands, such as the operating bands comprised in the so-called “6 GHz” band of the Wi-Fi 6E protocol.

The reflector could have a different shape, for an even greater reflectivity level.

It is also possible to enlarge the printed circuit, in order to add a series of reflectors (to obtain an antenna of the Yagi antenna type, for example) so as to increase the natural directivity of the radiation pattern of the halfwave dipole.

The corners of the printed circuit of the radiation pattern adaptation device are not necessarily cut.

It is described that the main antenna is positioned in a vertical plane by being oriented so as to form an angle of 45° with a horizontal plane. The radiofrequency system can be implemented, whatever the position and the orientation of the main antenna. The optimised position of the radiation pattern adaptation device with respect to the main antenna, which has been described earlier, is a relative position with respect to the position and to the orientation of the antenna.

All of the numerical values are given as an example. The frequency of the main antenna, for example, could be different from the frequencies mentioned in this case.

The radiofrequency system can comprise any number of main antennas.

The shape of the access point could be different. This could be, for example, a cylindrical shape of rectangular or square cross-section, with optionally rounded corners.

The radiofrequency system can be integrated in any type of equipment which implements a radiofrequency communication.

### APPENDICES

### Appendix 1: Table 1

Table 1 is divided, in this case, into two tables: 1A, 1B (which form one same table)

TABLE 1A

| | | | | | | Total offset directivity (dB) | | | | | | | | |
|---|---|---|---|---|---|---|---|---|---|---|---|---|---|---|
| | | | | | | 5180 MHz | | 5500 MHz | | 5800 MHz | | | | |
| | | | Total directivity (dB) | | | Relative | | Relative | | Relative | | Effectiveness (dB) | | |
| | | | 5180 | 5500 | 5800 | switch | Relative | switch | Relative | switch | Relative | 5180 | 5500 | 5800 |
| | | State | MHz | MHz | MHz | mode | position | mode | position | mode | position | MHz | MHz | MHz |
| +10 | mm | ON | 5 | 5.6 | 5.6 | −1 | 1.3 | −0.5 | 0.7 | 0 | 0.8 | −0.36 | −0.26 | −0.34 |
| | | OFF | 6 | 6.1 | 5.6 | | −1.4 | | −0.9 | | 0.2 | −0.31 | −0.27 | −0.43 |
| +5 | mm | ON | 5.5 | 6 | 5.5 | −0.3 | 0.8 | 0 | 0.3 | 0.1 | 0.9 | −0.53 | −0.35 | −0.53 |
| | | OFF | 5.8 | 6 | 5.4 | | −1.2 | | −0.8 | | 0.4 | −0.32 | −0.31 | −0.53 |
| Initial | | ON | 6.3 | 6.3 | 6.4 | 1.7 | | 1.1 | | 0.6 | | −1.58 | −0.74 | −0.65 |
| position 0 mm | | OFF | 4.6 | 5.2 | 5.8 | | | | | | | −0.3 | −0.38 | −0.81 |
| −5 | mm | ON | 5.4 | 5.4 | 4.6 | 0.5 | 0.9 | 0.7 | 0.9 | −0.8 | 1.8 | −1.98 | −0.7 | −0.6 |
| | | OFF | 4.9 | 4.7 | 5.4 | | −0.3 | | 0.5 | | 0.4 | −0.36 | −0.49 | −1.36 |
| −1 0 | mm | ON | 5.6 | 4.8 | 5.5 | 1 | 0.7 | 0.3 | 1.5 | −0.3 | 0.9 | −0.57 | −0.33 | −0.44 |

| | | | | | | | | | |
|---|---|---|---|---|---|---|---|---|---|
| OFF | 4.6 | 4.5 | 5.8 | 0 | 0.7 | 0 | −0.39 | −0.49 | −1.27 |

### Table 1B

Table 1B below comprises columns normally positioned on the right of table 1A (thus, for the frequency 5180 Mhz, the values 50.7 and 49.3 are associated with the line “+10 mm ON”, the values 55 and 45 are associated with the line “+10 mm OFF”, etc.

Bias

| | | |
|---|---|---|
| 5180 MHz | 5500 MHz | 5800 MHz |

| Eθ | Eφ | Eθ | Eφ | Eθ | Eφ |
|---|---|---|---|---|---|
| 50.7 | 49.3 | 51.5 | 48.5 | 54.4 | 45.6 |
| 55 | 45 | 55.4 | 44.6 | 55.6 | 44.4 |
| 51.2 | 48.8 | 50.4 | 49.6 | 51.7 | 48.3 |
| 53.6 | 46.4 | 54.8 | 45.6 | 55.5 | 44.5 |
| 53.3 | 46.7 | 51.5 | 48.5 | 52.0 | 48.0 |
| 52.3 | 47.7 | 52.9 | 47.1 | 55.5 | 44.5 |
| 58.2 | 41.8 | 54.6 | 45.4 | 53.4 | 46.6 |
| 53.5 | 46.5 | 52.4 | 47.6 | 56.5 | 43.5 |
| 55.8 | 44.2 | 54.6 | 45.4 | 54.1 | 45.9 |
| 58.3 | 41.7 | 58 | 42 | 58.6 | 41.4 |

Appendix 2: table 2

| | | | | | Total offset directivity (dB) | | | | | |
|---|---|---|---|---|---|---|---|---|---|---|
| | | | | | 5180 MHz | | 5500 MHz | | 5800 MHz | |
| | | | | | Relative | | Relative | | Relative | |
| | | Total directivity (dB) | | | switch | Relative | switch | Relative | switch | Relative |
| | State | 5180 MHz | 5500 MHz | 5800 MHz | mode | position | mode | position | mode | position |
| Inclination +30° | ON | 6 | 6.2 | 6 | 0.4 | −0.3 | 0.6 | −0.1 | 0.6 | −0.4 |
| | OFF | 5.6 | 5.6 | 5.4 | | 1 | | 0.4 | | −0.4 |
| Initial position 0 mm | ON | 6.3 | 6.3 | 6.4 | 1.7 | | 1.1 | | 0.6 | |
| | OFF | 4.6 | 5.2 | 5.8 | | | | | | |
| Inclination −30° | ON | 6.5 | 6.7 | 6.4 | 1.6 | 0.2 | 0.75 | 0.4 | 1 | 0 |
| | OFF | 4.9 | 5.95 | 5.4 | | 0.3 | | 0.75 | | −0.4 |

| | | | | Bias | | | | | |
|---|---|---|---|---|---|---|---|---|---|
| | Effectiveness (dB) | | | 5180 MHz | | 5500 MHz | | 5800 MHz | |
| | 5180 MHz | 5500 MHz | 5800 MHz | Eθ | Eφ | Eθ | Eφ | Eθ | Eφ |
| Inclination +30° | −0.33 | −0.26 | −0.36 | 51.2 | 48.8 | 50.7 | 49.3 | 53.1 | 46.9 |
| | −0.22 | −0.2 | −0.3 | 52.7 | 47.3 | 52.2 | 47.8 | 54.4 | 45.6 |
| Initial position 0 mm | −1.58 | −0.74 | −0.65 | 53.3 | 46.7 | 51.5 | 48.5 | 52.2 | 47.8 |
| | −0.3 | −0.38 | −0.81 | 52.3 | 47.7 | 52.9 | 47.1 | 55.5 | 44.5 |
| Inclination −30° | −1.24 | −0.56 | −0.54 | 52.1 | 47.9 | 52.5 | 47.5 | 52.6 | 47.4 |
| | −0.34 | −0.71 | −1 | 52.7 | 47.3 | 53 | 47 | 52.8 | 47.2 |

Appendix 3: table 3

| | Switch mode | | | | Gain (dBi) | | | | | NHPRP (%) | |
|---|---|---|---|---|---|---|---|---|---|---|---|
| Case | Switch 1 | Switch 2 | Switch 3 | Switch 4 | ANT1 | ANT2 | ANT3 | ANT 4 | UGC | +/−45° | +/−30° |
| 0 | NM | NM | NM | NM | 5 | 5.5 | 5.3 | 5.6 | 2.3 | 70 | 50 |
| 1 | OFF | OFF | OFF | OFF | 4.9 | 5.4 | 5.1 | 5.2 | 2.3 | 69 | 50 |
| 2 | OFF | ON | OFF | OFF | 4.5 | 6.6 | 5.1 | 5.1 | 2.2 | 76 | 54 |
| 3 | ON | ON | ON | ON | 6.9 | 6.6 | 6.9 | 6.4 | 2.2 | 80 | 58 |
| 4 | ON | ON | OFF | OFF | 6.9 | 6.6 | 5.1 | 5.1 | 2.3 | 77 | 56 |
| 5 | ON | ON | ON | OFF | 6.9 | 6.5 | 6.9 | 5.1 | 2.45 | 78 | 57 |

1. A radiofrequency system comprising a main antenna and a radiation pattern adaptation device comprising a printed circuit, on which two radiating strands and a reflector are printed, and on which a switching circuit is mounted, connected to the two radiating strands and arranged to be controlled, such that:
when the switching circuit is located in a blocked mode, a current circulation between the two radiating strands is blocked and the radiofrequency system has a first radiation pattern;
when the switching circuit is located in a passing mode, the current circulation between the two radiating strands is not blocked, such that the two radiating strands form a halfwave dipole antenna, the radiofrequency system thus having a second radiation pattern having, with respect to the first radiation pattern, an increased or decreased gain in at least one predetermined direction.

2. The radiofrequency system according to claim 1, wherein the main antenna extends into a first plane, and wherein the printed circuit of the radiation pattern adaptation device extends into a second plane perpendicular to the first plane.

3. The radiofrequency system according to claim 2, wherein a first distance between the main antenna and the printed circuit, along a first axis belonging to the first plane and perpendicular to the second plane, is equal to λ/8, and wherein a second distance between the main antenna and the printed circuit, along a second axis belonging to the second plane and perpendicular to the first axis, is equal to λ/16.

4. The radiofrequency system according to claim 1, wherein a transmission coefficient between the main antenna and the radiation pattern adaptation device is between −15 dB and −6 dB.

5. The radiofrequency system according to claim 1, wherein the two radiating strands extend successively along a length of the printed circuit, and wherein the reflector comprises a main portion which extends over all of said length.

6. The radiofrequency system according to claim 5, wherein the reflector further comprises two secondary portions which each extend from a distinct end of the main portion by being perpendicular to it.

7. The radiofrequency system according to claim 1, wherein each radiating strand is connected to the switching circuit by a coplanar waveguide.

8. The radiofrequency system according to claim 7, wherein:
the radiating strands, the reflector, the coplanar waveguides and the switching circuit are located on a first layer of the printed circuit, the coplanar waveguides and the switching circuit being positioned in a central portion of the first layer, the radiating strands extending on either side of said central portion;
the printed circuit comprises a main ground plane printed on a second layer of the printed circuit, the main ground plane being located in a central portion of the second layer;
ground tracks of the coplanar waveguides, a ground plane of the switching circuit, as well as the reflector, being connected to the main ground plane.

9. The radiofrequency system according to claim 1, wherein the switching circuit comprises a single pole single throw switch.

10. The radiofrequency system according to claim 1, further comprising a support made of a single part comprising a first part arranged to carry the main antenna and a second part arranged to carry the radiation pattern adaptation device, the second part being arranged to be able to manually insert and uninsert the radiation pattern adaptation device.

11. The radiofrequency system according to claim 1, comprising a plurality of main antennas each associated with a distinct radiation pattern adaptation device.

12. The radiofrequency system according to claim 11, the main antennas being arranged to operate according to the MIMO technique.

13. Equipment comprising the radiofrequency system according to claim 1.

14. The equipment according to claim 13, the equipment being an access point.

15. A control method, implemented by a processing unit of the equipment according to claim 13, and comprising the steps of:
acquiring a setpoint aiming to configure a radiation pattern of the radiofrequency system according to the first radiation pattern or the second radiation pattern; and
producing a control voltage which depends on said setpoint, and applying said control voltage at the input of the switching circuit.

16. (canceled)

17. A non-transitory computer-readable storage medium, on which a computer program comprising instructions which make a processing unit of equipment to execute the steps of the control method according to claim 15 is stored.
